(19) United States
(12) Patent Application Publication
(10) Pub. No.: US 2026/0134575 A1
(43) Pub. Date: May 14, 2026

(54) Virtual Pan-Camera for Object Tracking Applications

(71) Applicant: Zebra Technologies Corporation, Lincolnshire, IL (US)

(72) Inventors: Miroslav Trajkovic, Setauket, NY (US); Justin H. Barish, Kings Park, NY (US); Mahmudul H. Bhuiyan, Centereach, NY (US)

(73) Assignee: Zebra Technologies Corporation, Lincolnshire, IL (US)

(21) Appl. No.: 18/942,320

(22) Filed: Nov. 8, 2024

(51) Int. Cl. G06T 7/80; G06K 7/14; G06T 7/13; G06T 7/246; G06T 7/70; G06V 10/147

(52) U.S. Cl. CPC G06T 7/80; G06K 7/1447; G06T 7/13; G06T 7/246; G06T 7/70; G06V 10/147

(57) ABSTRACT

Methods for modular activation of imaging sensors are disclosed herein. An example computing system includes: an imaging device including an imaging sensor having a field of view (FOV) of high resolution, one or more memories including computer-executable instructions stored thereon that, when executed by one or more processors cause the computing system to: determine a portion of the FOV associated with a position of an object; activate a portion of the imaging sensor corresponding to the portion of the FOV associated with the position of the object; and analyze one or more images captured by the portion of the imaging sensor to identify a feature of the object.

### BACKGROUND

Conventional techniques for image processing applications, such as machine vision applications, barcode scanning applications, and object recognition applications, generally employ either imaging sensors with a wide field of view or imaging sensors of high resolution to analyze objects moving across the sensors' fields of view.

To sufficiently analyze the objects, such image processing applications typically require high resolution frames and imaging sensors capable of operating at a high frame rate. However, a higher resolution necessitates a lower frame rate, and conversely, a higher frame rate necessitates a lower resolution. Some conventional techniques involve stitching together multiple overlapping fields of view from multiple imaging sensors to balance this tradeoff of resolution and frame rate. However, such conventional techniques present both cost and logistical challenges associated with managing and synchronizing the two or more sensors. The conventional techniques additionally require streaming large amounts of data at high speed and vast computational resources, subsequently resulting in high power consumption, as well as requiring high cost sensors and high cost image processors.

### SUMMARY

In an embodiment, the present invention is a computing system comprising: one or more processors; an imaging device including an imaging sensor having a field of view (FOV) of high resolution, wherein the imaging device is in a fixed position relative to the FOV; and one or more memories including computer-executable instructions stored thereon that, when executed by the one or more processors cause the computing system to: (i) determine a portion of the FOV associated with a position of an object; (ii) activate a portion of the imaging sensor corresponding to the portion of the FOV associated with the position of the object; and (iii) analyze one or more images captured by the portion of the imaging sensor to identify a feature of the object.

In a variation of this embodiment, the computer-executable instructions, when executed by the one or more processors, determine the portion of the FOV associated with the position of the object by causing the computing system to: detect, in an initial image captured by the imaging sensor, an image feature associated with the object; identify the detected image feature across at least two consecutive images; determine, based on the at least two consecutive images, a motion of the object within the FOV; and determine, based on the motion of the object, a predicted position of the object within the FOV, in an image subsequent to the at least two consecutive images, corresponding to the portion of the FOV associated with the position of the object.

In a variation of this embodiment, detecting the image feature includes detecting at least one of: a one dimensional (1D) barcode, a symbology, one or more corners of an object, or one or more edges of an object.

In a variation of this embodiment, the computer-executable instructions, when executed by the one or more processors, determine the portion of the FOV associated with the position of the object by causing the computing system to: detect, in an initial image captured by the imaging sensor, a blurred image feature associated with the object; determine, based on the blurred image feature, a motion of the object within the FOV; and determine, based on the motion of the object, a predicted position of the object within the FOV, in an image subsequent to the initial image, corresponding to the portion of the FOV associated with the position of the object.

In a variation of this embodiment, the computer-executable instructions, when executed by the one or more processors, determine the portion of the FOV associated with the position of the object by causing the computing system to: determine, using an optical flow algorithm and based on at least two consecutive images, a predicted position of the object within the FOV, in an image subsequent to the at least two consecutive images, corresponding to the portion of the FOV associated with the position of the object.

In a variation of this embodiment, the imaging sensor is an integrated optical flow imaging sensor.

In a variation of this embodiment, the computer-executable instructions, when executed by the one or more processors, further cause the computing system to: identify a symbology depicted within the identified feature of the object; and decode the symbology depicted within the identified feature of the object.

In a variation of this embodiment, the computer-executable instructions, when executed by the one or more processors, further cause the computing system to: identify, using a computer vision algorithm and based on the identified feature of the object, the object.

In a variation of this embodiment, the portion of the imaging sensor is a sub-section of a pixel area of the imaging sensor and wherein the pixel area of the imaging sensor corresponds to the FOV of the imaging sensor.

In a variation of this embodiment, the computer-executable instructions, when executed by the one or more processors, further cause the computing system to: bound the pixel area of the imaging sensor based on the portion of the FOV associated with the position of the object, wherein the pixel area is bound horizontally, bound vertically, or bound both horizontally and vertically.

In a variation of this embodiment, the imaging sensor is a first imaging sensor and the computing system further comprises: a second sensor configured to capture sensor data associated with the object; and the computer-executable instructions, when executed by the one or more processors, further cause the computing system to: determine the position of the object based on the sensor data captured by the second sensor.

In a variation of this embodiment, the second sensor is: a light detection and ranging (LiDAR) sensor, a depth tracking sensor, a time of flight sensor, or an ultra-sonic sensor.

In a variation of this embodiment, the imaging device is included in: a bi-optic imaging station, or a machine vision station.

In another embodiment, the present invention is a computer-implemented method for modular activation of an imaging sensor comprising: (i) determining a portion of a FOV of an imaging sensor associated with a position of an object, the imaging sensor included in an imaging device in a fixed position relative to the FOV; (ii) activating a portion of the imaging sensor corresponding to the portion of the FOV associated with the position of the object; and (iii) analyzing one or more images captured by the portion of the imaging sensor to identify a feature of the object.

In a variation of this embodiment, the computer-implemented method further comprises: detecting, in an initial image captured by the imaging sensor, an image feature associated with the object; identifying the detected image feature across at least two consecutive images; determine, based on the at least two consecutive images, a motion of the object within the FOV; and determine, based on the motion of the object, a predicted position of the object within the FOV, in an image subsequent to the at least two consecutive images, corresponding to the portion of the FOV associated with the position of the object.

In a variation of this embodiment, detecting the image feature includes detecting at least one of: a one dimensional (1D) barcode, a symbology, one or more corners of an object, or one or more edges of an object.

In a variation of this embodiment, the computer-implemented method further comprises: detecting, in an initial image captured by the imaging sensor, a blurred image feature associated with the object; determining, based on the blurred image feature, a motion of the object within the FOV; and determining, based on the motion of the object, a predicted position of the object within the FOV, in an image subsequent to the initial image, corresponding to the portion of the FOV associated with the position of the object.

In a variation of this embodiment, the computer-implemented method further comprises: based on at least two consecutive images, determining, using an optical flow algorithm, a predicted position of the object within the FOV, in an image subsequent to the at least two consecutive images, corresponding to the portion of the FOV associated with the position of the object.

In a variation of this embodiment, the imaging sensor is an integrated optical flow imaging sensor.

In a variation of this embodiment, the computer-implemented method further comprises: identifying a symbology depicted within the identified feature of the object; and decoding the symbology depicted within the identified feature of the object.

In a variation of this embodiment, the computer-implemented method further comprises: identifying, using a computer vision algorithm, the object based on the identified feature of the object.

In a variation of this embodiment, the portion of the imaging sensor is a sub-section of a pixel area of the imaging sensor and the pixel area of the imaging sensor corresponds to the FOV of the imaging sensor; and the computer-implemented method further comprises: bounding the pixel area of the imaging sensor based on the portion of the FOV associated with the position of the object, wherein the pixel area is bound horizontally, bound vertically, or bound both horizontally and vertically.

In a variation of this embodiment, the imaging sensor is a first imaging sensor; and the computer-implemented method further comprises: determining the position of the object based on sensor data captured by a second sensor.

In a variation of this embodiment, the second sensor is: a light detection and ranging (LiDAR) sensor, a depth tracking sensor, a time of flight sensor, or an ultra-sonic sensor.

In a variation of this embodiment, the imaging device is included in: a bi-optic imaging station, or a machine vision station.

In yet another embodiment, the present invention is a non-transitory computer readable medium containing program instructions that when executed, cause a computer to: (i) determine a portion of a FOV of an imaging sensor associated with a position of an object, the imaging sensor included in an imaging device in a fixed position relative to the FOV; (ii) activate a portion of the imaging sensor corresponding to the portion of the FOV associated with the position of the object; and (iii) analyze one or more images captured by the portion of the imaging sensor to identify a feature of the object.

In a variation of this embodiment, the program instructions, when executed by the one or more processors, further cause the computer to: detect in an initial image captured by the imaging sensor, an image feature associated with the object; identify the detected image feature across at least two consecutive images; determine, based on the at least two consecutive images, a motion of the object within the FOV; and determine, based on the motion of the object, a predicted position of the object within the FOV, in an image subsequent to the at least two consecutive images, corresponding to the portion of the FOV associated with the position of the object.

In a variation of this embodiment, detecting the image feature includes detecting at least one of: a one dimensional (1D) barcode, a symbology, one or more corners of an object, or one or more edges of an object.

In a variation of this embodiment, the program instructions, when executed by the one or more processors, further cause the computer to: detect in an initial image captured by the imaging sensor, a blurred image feature associated with the object; determine, based on the blurred image feature, a motion of the object within the FOV; and determine, based on the motion of the object, a predicted position of the object within the FOV, in an image subsequent to the initial image, corresponding to the portion of the FOV associated with the position of the object.

In a variation of this embodiment, the program instructions, when executed by the one or more processors, further cause the computer to: based on at least two consecutive images, determine, using an optical flow algorithm, a predicted position of the object within the FOV, in an image subsequent to the at least two consecutive images, corresponding to the portion of the FOV associated with the position of the object.

In a variation of this embodiment, wherein the imaging sensor is an integrated optical flow imaging sensor.

In a variation of this embodiment, the program instructions, when executed by the one or more processors, further cause the computer to: identify a symbology depicted within the identified feature of the object; and decode the symbology depicted within the identified feature of the object.

In a variation of this embodiment, the program instructions, when executed by the one or more processors, further cause the computer to: identify, using a computer vision algorithm, the object based on the identified feature of the object.

In a variation of this embodiment, the portion of the imaging sensor is a sub-section of a pixel area of the imaging sensor, wherein the pixel area of the imaging sensor corresponds to the FOV of the imaging sensor.

In a variation of this embodiments, the program instructions, when executed by the one or more processors, further cause the computer to: bound the pixel area of the imaging sensor based on the portion of the FOV associated with the position of the object, wherein the pixel area is bound horizontally, bound vertically, or bound both horizontally and vertically.

In a variation of this embodiment, the imaging sensor is a first imaging sensor and the program instructions, when executed by the one or more processors, further cause the computer to: determine the position of the object based on sensor data captured by a second sensor.

In a variation of this embodiment, the second sensor is: a light detection and ranging (LiDAR) sensor, a depth tracking sensor, a time of flight sensor, or an ultra-sonic sensor.

In a variation of this embodiment, the imaging device is included in: a bi-optic imaging station, or a machine vision station.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a block diagram of an example logic circuit for implementing example methods and/or operations for modular activation of an imaging sensor, in accordance with some embodiments described herein.

FIG. 2A depicts illustrates a perspective view of an example checkout workstation, in accordance with some embodiments described herein.

FIG. 2B depicts an example operating environment for a machine vision imaging system, in accordance with some embodiments described herein.

FIG. 3 depicts an example scanning scenario, in accordance with some embodiments described herein.

FIG. 4 depicts an exemplary computer-implemented method for modular activation of an imaging sensor, in accordance with some embodiments described herein.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

As mentioned above, conventional imaging techniques face a mutually exclusive tradeoff between resolution and frame rate.

The present aspects may relate to, inter alia, a computing system for modular activation of imaging sensors. Using the techniques provided herein, portions of an imaging sensor (e.g., portions or subsections of the pixel area of an imaging sensor) may be activated based on a shifting region of interest within the FOV of the imaging sensor and corresponding to a moving object.

Advantageously, the computing system provided herein may capture high resolution images at a high frame rate by activating a portion of a high resolution imaging sensor (e.g., based on the position of an object within the FOV). Moreover, such modular activation of a high resolution imaging sensor may result in smaller high resolution images, as compared to images acquired by activating the entire pixel area of a high-resolution sensor, while preserving the wider field of view of the entire pixel area. Furthermore, through modular activation of an imaging sensor and acquisition of such high resolution images, the computing system provided herein may acquire images at a high frame rate typically only achievable using lower resolution imaging sensors. Advantageously the computing system provided herein may stream smaller amounts of data, reduce power consumption, and expend fewer computational resources, thereby requiring less processing time compared to conventional techniques.

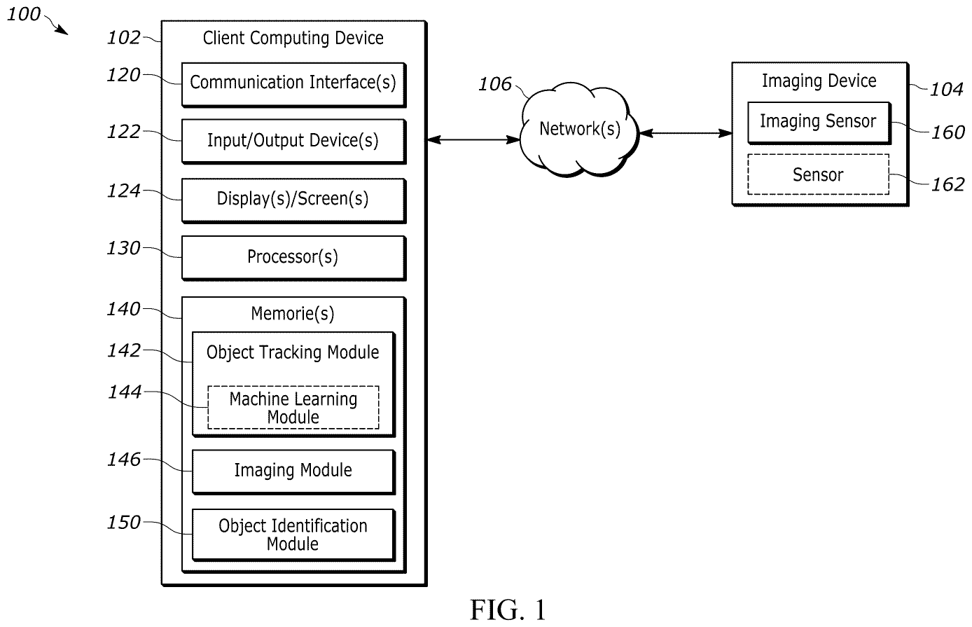

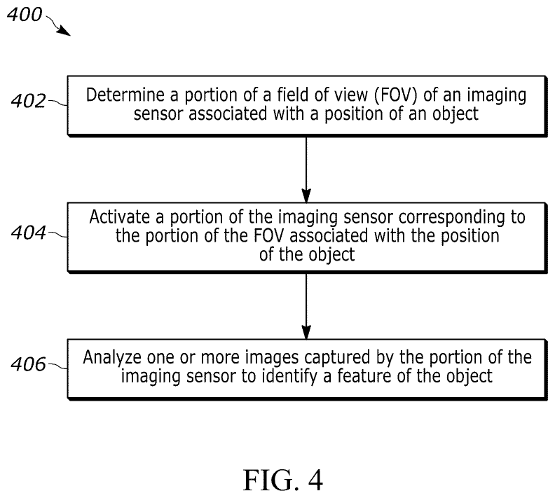

Referring now to the drawings, FIG. 1 is a block diagram representative of an example computing environment 100 capable of implementing the example methods and/or operations described herein, including, for example, one or more steps of the method 400 of FIG. 4 discussed in greater detail below. The computing environment 100 of FIG. 1 includes a client computing device 102, an imaging device 104, and one or more networks 106. The exemplary network 106 of FIG. 1 may be a single communication link directly connecting the client computing device 102 and the imaging device 104 (e.g., a direct wireless link), or one or more networks 106 may include multiple links (e.g., connecting the client computing device 102, the imaging device 104, and an additional imaging device) and/or communication networks of one or more types (e.g., one or more wired and/or wireless local area networks (LANs), and/or one or more wired and/or wireless wide area networks (WANs) such as the Internet, public networks, private networks, etc.). For ease of reading herein (and not for limitation purposes), the one or more networks 106 may be referred to using the singular tense.

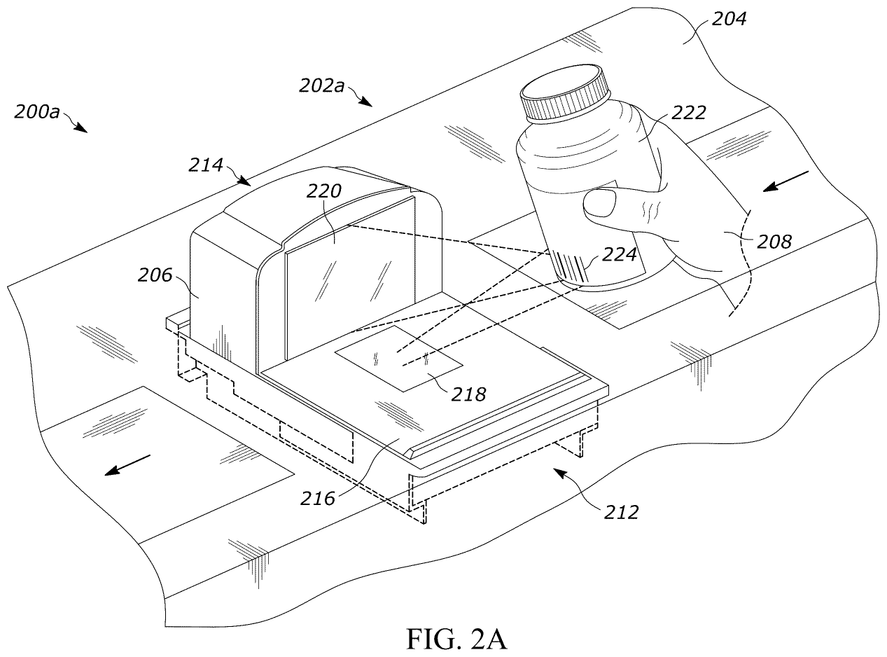

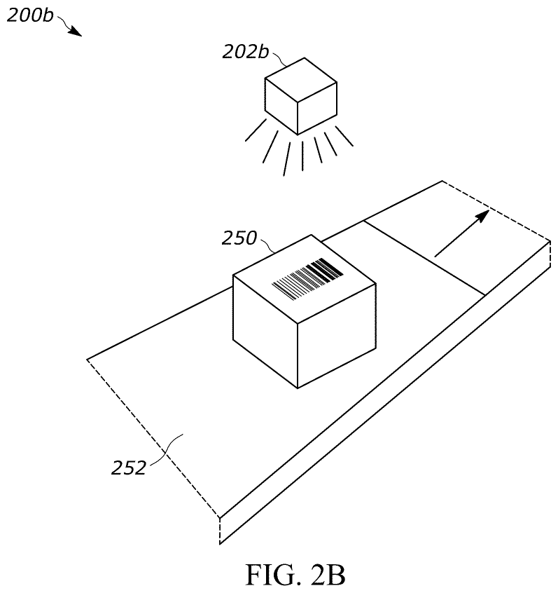

The client computing device 102 includes one or more communication interface(s) 120, one or more input/output device(s) 122, one or more display(s)/screen(s) 124, one or more processors 130, and one or more memories 140. The memories 140 include an object tracking module 142, an imaging module 146, and an object identification module 150. The client computing device 102 may be an individual server, a group (e.g., cluster) of multiple servers, a computing device (e.g., a scanning station, a personal computer, a laptop, a smart phone, a tablet, a wearable device, etc.), or another suitable type of computing device or system (e.g., a collection of computing resources). In some embodiments, the client computing device 102 may be included in and/or associated with a scanning station (e.g., a bi-optical or “bi-optic” scanning station, e.g., as discussed with respect to FIG. 2A below, a self-checkout station, etc.), a machine vision imaging system, an object recognition device, etc.

The one or more communication interfaces 120 may enable communication with other machines (e.g., imaging device 104) via, for example, the one or more networks 106. The example communication interface 120 may include any suitable type of communication interface(s) (e.g., wired and/or wireless interfaces) configured to operate in accordance with any suitable protocol(s). For example, the communication interfaces 120 may be configured to transmit and receive data using a suitable wired communication protocol such as an Ethernet protocol, a USB protocol, a UART protocol, an I2C protocol, a SPI protocol, or wireless communication protocols such as a Bluetooth protocol, a Wi-Fi® (IEEE 802.11 standard) protocol, a near-field communication (NFC) protocol, a cellular (e.g., GSM, CDMA, LTE, WiMAX, etc.) protocol, a peer-to-peer wireless protocol, a short-range wireless protocol, and/or other suitable wired or wireless communication protocols. In some embodiments, for data throughput and efficiency reasons, a combination of such protocols may be used by the communication interface 120. In some embodiments, the communication interface 120 may be a network interface controller (NIC) and may include any suitable NICs, such as wired/wireless controllers (e.g., Ethernet controllers), and facilitate bidirectional/multiplexed networking over the network 106 between the client computing device 102 and the imaging device 104 and/or other components of the environment 100 (e.g., a remote computing device, another imaging device, etc.).

The input/output (I/O) devices 122 may enable receipt of user input and communication of output data to the user. The I/O devices 122 may include one or more suitable types of user input devices, such as keyboards, touch screen displays, microphones, mice, touchpads, and/or any suitable types of remote and/or local user input devices. Further, the I/O devices 122 may include one or suitable types of output devices, such as touch screen displays, speakers, and the like. In some embodiments, the I/O devices 122 may include one or more local interfaces, and/or may include one or more remote interfaces that are communicatively connected to the client computing device 102 and/or the imaging device 104 via the network 106 (e.g., that are provided by an application, web browser, or other software executing on a device of a user).

The one or more displays/screens 124 may present or display information to a user. The display 124 may use any suitable display technology (e.g., LED, OLED, LCD, etc.). In some embodiments, the display 124 may not be integral to the client computing device 102 and may receive instructions from the client computing device 102 via wired and/or wireless transmissions over communication interface 120, for example. In some embodiments, the display 124 may be integrated with I/O device 122 as a touchscreen display. Further, display 124 and I/O device 122 may combine to form an integral user interface to enable a user of the client computing device 102 to interact with graphical user interfaces (GUIs) provided by client computing device 102. For example, the displays 124 and/or the I/O devices 122 may be configured to present image data captured by the imaging device 104 (e.g., captured by the imaging sensor 160) for review by a user. As another example, the displays 124 and/or the I/O devices 122 may enable a user to configure image/data acquisition parameters stored in the memories 140. As yet another example, the displays 124 and/or the I/O devices 122 may enable a user to review an indication of an object swiped through the scanning region of the imaging device 104 and identified by client computing device 102 (e.g., via the object identification module 150). For ease of reading (and not limitation) purposes, the I/O devices 122 and/or the displays/screens 124 may be referred to herein using the singular tense.

The processors 130 may include one or more microprocessors, controllers, and/or any suitable type of processor, and the memories 140 (e.g., volatile memory, non-volatile memory) may be accessible by the processor 130 (e.g., via a memory controller). The processor 130 may interact with the memory 140 to obtain, for example, machine-readable instructions and/or computer-executable instructions stored in the memory 140 corresponding to, for example, the operations represented by the flowcharts of this disclosure (e.g., the method 400 of FIG. 4).

The memories 140 of the client computing device 102 of FIG. 1 may store instructions for executing an object tracking module 142. Generally speaking, the object tracking module 142 may receive and analyze data captured by the imaging sensor 160 and/or the additional sensor 162 of the imaging device 104 to determine a current or future (e.g., predicted) position of an object within the FOV(s) of the imaging device 104, and may send the determined position to the imaging module 146 for modular activation of a portion of the imaging sensor 160 of the imaging device 104 corresponding to the current or future position of the object. For instance, the object tracking module 142 may determine a predicted position of an object based on image data, LiDAR data, depth data, three dimensional sensor data, and/or other sensor data from the imaging sensor 160 and/or the additional sensor 162 of the imaging device 104. Furthermore, the object tracking module 142 may determine a portion of, or position within, the FOV of the imaging sensor 160 associated with a current or future position of the object and send the determined portion of the FOV or position within the FOV of the imaging sensor 160 associated with the current or future position of the object to the imaging module 146.

In some examples, two or more imaging sensors (e.g., the imaging sensor 160 and an additional imaging sensor) may combine to form a stereo vision system, or a stereoscopic vision system, capable of capturing depth data. Expanding on this example, the object tracking module 142 may include instructions for analyzing images from such stereo vision depth sensors (e.g., an image from the imaging sensor 160 and an image from the additional imaging sensor) to determine or identify depth in the images and determine a current position of an object, or predict a future position of an object, depicted in the images.

Furthermore, in some examples, the object tracking module 142 may include one or more trained machine learning (ML) models 144 (e.g., a convolutional neural network, a recurrent neural network, a transformer or language model, a graph neural network, etc.) suitable for motion and/or position analysis in image data and/or sensor data (e.g., depth data, three dimensional sensor data, LiDAR data, etc.).

Additionally or alternatively, in some examples, the object tracking module 142 may include instructions for detecting an image feature associated with an object in one or more initial images captured by the imaging sensor 160 and determining, based on the detected image feature, a predicted position of the object within the FOV of the imaging sensor 160. For example, the object tracking module 142 may identify a detected image feature across at least two consecutive images captured by an imaging device, and for determining a predicted motion of the object (e.g., a velocity, acceleration, and/or direction of the object) within the FOV of the imaging device based on the two or more consecutive images and the detected feature (e.g., using the trained ML model(s) 144, a standard feature tracking algorithm, an edge detection algorithm, etc.).

As another example, the detected image feature may be a blurred image feature associated with the object and the object tracking module 142 may determine a motion or a predicted motion of the object within the FOV of the imaging sensor 160 based on the blurred image feature (e.g., using a motion estimation from blur algorithm).

In some embodiments, the object tracking module 142 of the memories 140 may include or store an optical flow algorithm (e.g., the trained ML models 144, FlowNet, recurrent all-pairs field transforms or RAFT, another ML based optical flow algorithm, a non ML based optical flow algorithm, etc.) for computing the optical flow in image data and/or sensor data captured by the imaging device 104 and determining a predicted position of the object within the FOV(s) of the imaging device 104. Further, the object tracking module 142 may include instructions for determining, using an optical flow algorithm, a motion of the object (e.g., a velocity, acceleration, and/or direction of the object) within the FOV(s) of the imaging device 104 based on a computed optical flow for two or more consecutive images captured by the imaging device. Additionally or alternatively, the imaging sensor 160 may be an integrated optical flow imaging sensor and the imaging sensor 160 may determine the predicted position of the object within the FOV based on the two or more consecutive images using an optical flow algorithm. For example, an integrated optical flow sensor of the imaging device 104 may include hardware and software modules configured to compute the optical flow across at least two consecutive images captured by the imaging device 104 as the images are captured. In some embodiments, an integrated optical flow sensor of the imaging device 104 may send an indication of a computed optical flow, a predicted motion of an object within the FOV(s) of the imaging device 104, and/or a predicted position of an object within the FOV(s) to the object tracking module 142 and/or the imaging module 146. For example, based on a computed optical flow determined by an integrated optical flow sensor of the imaging device 104, the object tracking module 142 may determine a predicted position of the object.

In some embodiments, the object tracking techniques described herein (e.g., blur from motion techniques, feature tracking techniques, optical flow techniques, AI or ML based tracking techniques, etc.) may be implemented in, or near, real time for an image (e.g., the motion of an object may be estimated while the image is being acquired), and accordingly, a predicted position of the object within the FOV and a corresponding portion of the pixel area of an imaging sensor (e.g., imaging sensor 160) may be determined and activated before a subsequent image is captured.

The memories 140 of the client computing device 102 of FIG. 1 may also store instructions for executing an imaging module 146. In some embodiments, the imaging module 146 may include instructions for modular activation of an imaging sensor such as the imaging sensor 160, and/or one or more additional imaging sensors of the computing environment 100. Generally speaking, the imaging module 146 may include instructions for determining a portion of the FOV of the imaging sensor 160 associated with an object moving through or across the FOV (e.g., an object passing through the scanning region of the imaging device 104) based on a predicted position of the object determined by the object tracking module 142. Additionally or alternatively, the imaging module 146 may generate and/or store one or more sets of image acquisition parameters for modular activation of the pixel area of the imaging sensor 160(e.g., activation of at least a portion of the imaging sensor 160). In some embodiments, the imaging module 146 may generate image acquisition parameters based on a position of an object within the FOV(s) of an imaging device (e.g., a predicted position determined by the object tracking module 142 using a blur to motion algorithm, an optical flow algorithm, the trained ML models 144, etc.). For example, the imaging module 146 may include instructions for associating a portion of an FOV of an imaging sensor, or a portion of the imaging sensor itself (e.g., a portion of the pixel area of the sensor), with the predicted position of an object determined by the object tracking module 142. Generally, the entire pixel area of an imaging sensor may correspond to the full FOV of the imaging sensor, while a portion of a pixel area may correspond to a portion of the FOV. In some embodiments, the imaging module 146 may generate image acquisition parameters for activation of a sub-section of the pixel area of an imaging sensor (e.g., a portion of the pixel area associated with a predicted position of an object). For example, the imaging device 104 may bound the pixel area of the imaging sensor 160 to be activated, in accordance with the image acquisition parameters generated by the imaging module 146 based on a predicted position of an object within the FOV of the imaging sensor 160 determined by the object tracking module 142. The imaging device 104 may in turn cause the bounded pixel area of the imaging sensor 160 to activate. Expanding on this example, the acquisition parameters may specify that the pixel area of the imaging sensor 160 is to be bounded horizontally and/or vertically. In some embodiments, the imaging module 146 may include instructions that cause the client computing device 102 to send the image acquisition parameters to the imaging device 104 (e.g., via the network 106).

The memories 140 of the client computing device 102 of FIG. 1 may also store instructions for executing an object identification module 150. The object identification module 150 may analyze one or more images captured by the imaging sensor 160 (e.g., one or more images captured by an activated portion of an imaging sensor) to identify one or more features of an object moving through the FOV(s) of the imaging sensor 160. In some embodiments, objects included in the FOV of the imaging sensor 160 may generally have a visible, or at least partially visible, symbology (e.g., a barcode affixed thereon, imprinted thereon, presented thereon, etc.). In various embodiments, the object identification module 150 may decode symbologies depicted in image data captured by the imaging sensor 160 and/or within identified features of such image data. The object identification module 150 may additionally include instructions for determining an identification of an object included in, or depicted within, image data based on the decoded symbology, and may include instructions for communicating the identification of the object to other components of the example computing environment 100 (e.g., a remote computing device) and/or to other components of the memory 140 (e.g., the imaging module 146). In some embodiments, the object identification module 150 may include a computer vision algorithm and instructions for identifying an object based on identified features of the object using the computer vision algorithm. For example, the computer vision algorithm may be a ML algorithm/model (e.g., one or more trained ML models similar to the trained ML models 144 such as a convolutional neural network, a ML classifier, a transformer, etc.), an edge detection algorithm, a feature detection and matching algorithm, etc.

Returning to the example imaging device 104 of FIG. 1, the imaging device 104 includes an imaging sensor 160, and in some embodiments, an additional sensor 162. In some embodiments, the imaging device 104 may be included in a scanning station, a machine vision imaging system, an object recognition device, etc. In some embodiments, the field(s) of view of the imaging device 104 (e.g., the field of view of the imaging sensor 160 and/or the field of view of the additional sensor 162) may be associated with a scanning region of the imaging device 104. For example, a scanning region of the imaging device 104 may be an area through which objects are swiped, or in which objects are placed, so that symbologies (e.g., one dimensional barcodes, two dimensional barcodes such as quick response or QR codes, etc.) affixed thereto or presented thereon may be identified. In some embodiments, the imaging device 104 includes one or more imaging sensors 160 and/or one or more additional sensors 162. For ease of reading herein (and not for limitation purposes), the one or more imaging sensors 160 and the one or more additional sensors 162 may be referred to using the singular tense.

Additionally, the imaging device 104 may be communicatively coupled to the client computing device 102 via, for example, one or more wired connections, one or more wireless connections, and/or one or more suitable communication interfaces (e.g., a communication interface similar to the communication interface 120 of the client computing device 102, as described above) and over one or more networks (e.g., over the network 106). In some embodiments, the imaging device 104 may be integrated with the client computing device 102. Additionally or alternatively, the imaging sensor 160 and/or the additional sensor 162 may be integrated with the client computing device 102. In some embodiments, the imaging sensor 160 and/or the additional sensor 162 may be external to the imaging device 104 and/or the client computing device 102 and may be communicatively coupled to the imaging device 104 and/or the client computing device 102 via a network (e.g., the network 106), by a direct communication link, or by another suitable communication means. It should be noted that other configurations of the one or more imaging sensors 160 and the one or more additional sensors 162 are possible.

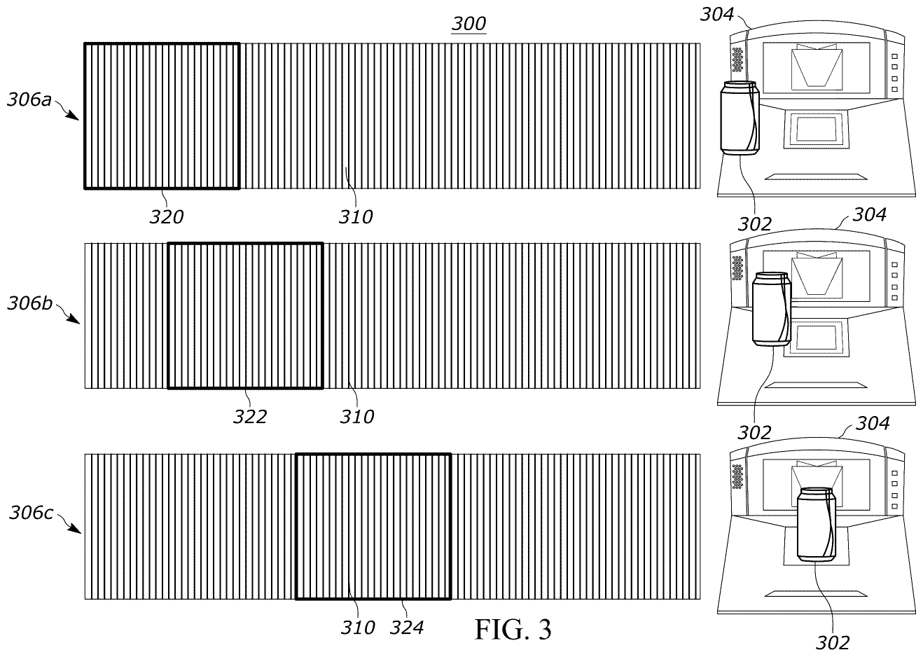

The imaging sensor 160 may correspond to a field of view (FOV) associated with a scanning region of the imaging device 104. In some embodiments, the imaging device 104, the imaging sensor 160, and/or the additional sensor 162 may be in a fixed position relative to the FOV(s) of the imaging device 104 (e.g., the FOV of the imaging sensor 160 and/or the FOV of the additional sensor 162 may be fixed). In some embodiments, the imaging device 104, the imaging sensor 160, and/or the additional sensor 162 may in a fixed position (e.g., the imaging device 104 and/or the sensors may be stationary and not moveable by a user). In some embodiments, the imaging sensor 160 may be a large/high resolution imaging sensor with a wide field of view (e.g., an imaging sensor with a large pixel area and/or a high number of pixels). In some examples, the imaging sensor 160 may be an imaging sensor with a resolution of five megapixels or more. In some embodiments, the imaging sensor 160 may have a wide field of view and the imaging sensor 160 may be mounted such that the wider dimension of the FOV is substantially parallel to the typical path of objects through the scanning region of the imaging device 104. Furthermore, through modular activation of the imaging sensor 160, slit frames (e.g., the slit frame 310 of FIG. 3) may be captured sequentially with a shifting sensor-based slit frame region of interest (e.g., the collection of slit frames 320 of FIG. 3) that follows the motion of objects moving across the FOV of the imaging sensor 160.

The imaging sensor 160 may be configured to receive and execute instructions (e.g., image acquisition parameters) from the client computing device 102 (e.g., initiated by the imaging module 146 of the client computing device 102) that cause the imaging sensor 160 to capture imaging data. As mentioned above, the imaging device 104 may cause a portion of the pixel area of the imaging sensor 160 to activate and capture imaging data for a corresponding portion of the FOV in accordance with image acquisition parameters from the imaging module 146. Said another way, the image acquisition parameters may specify that a portion of the pixel area to be activated and/or the image acquisition parameters may specify that a remaining portion of the pixel area that is to be deactivated. For example, the portion of the pixel area may be a quadrant or section of the entire pixel area of the imaging sensor 160. As mentioned above, the activated portion of the imaging sensor 160 may correspond to a portion of the FOV of the imaging sensor associated with a predicted position of an object within the FOV (e.g., a predicted position of an object moving through the FOV at some point in the future). Moreover, for subsequent images captured by the imaging sensor 160 (e.g., as the object moves through or across the FOV of the imaging sensor 160), the image acquisition parameters may specify that a different portion of the imaging sensor 160 is to be activated based on a subsequent predicted position of the object. For example, the image acquisition parameters may specify a first portion of the pixel area of the imaging sensor 160, corresponding to a first predicted position of the object within the FOV, to be activated and the image acquisition parameters may specify a second portion of the pixel area of the imaging sensor 160 (e.g., a portion of the pixel area including at least some pixels not included in the first portion of the pixel area), corresponding to a second predicted position of the object within the FOV, to be activated.

In some embodiments, one or more imaging sensors 160 may correspond to one or more respective FOV (e.g., a first imaging sensor 160 corresponding to a first FOV, a second imaging sensor of the imaging device 104 corresponding to a second FOV, etc.) associated with the scanning region of the imaging device 104. In some embodiments, a single split-view imaging sensor 160, having two distinct FOV (e.g., in a bi-optic scanning scenario), may correspond to a first FOV and a second FOV associated with the scanning region of the imaging device 104. Furthermore, a portion of at least one of the one or more imaging sensors 160 may be activated (e.g., one or more portions of one or more respective pixel areas for the one or more imaging sensors 160 may be activated) based on the predicted position of an object. It should be noted that other configurations of the one or more imaging sensors 160 are possible. For example, a single imaging sensor 160 may correspond to one or more FOV (e.g., a first FOV, a first and a second FOV, etc.) in some embodiments, while two or more imaging sensors 160 may correspond to two or more FOV in some embodiments.

At a high level, the additional sensor 162 may be configured to capture image data, depth data, three-dimensional sensor data, and/or other sensor data (e.g., LiDAR data, sonic data, etc.) for an object moving through the FOV(s) of the imaging device 104 based on a set of acquisition parameters generated by the client computing device 102. Generally, the additional sensor 162 may be any sensor capable of capturing data suitable for predicting the positions of objects within a FOV (e.g., an imaging sensor, a LiDAR sensor, a depth tracking sensor, a time of flight sensor, an ultrasonic sensor). The additional sensor 162 may be (or include) hardware sensors, such as imaging sensors, light detection and ranging (LiDAR) sensors, depth tracking sensors, time of flight sensors, ultra-sonic sensors, etc., and the additional sensor 162 may be configured to capture sensor data used to determine a position of an object (e.g., image data, LiDAR data, depth data, etc.) associated with objects moving across the FOV of the imaging sensor 160. In some embodiments, the FOV of the additional sensor 162 may overlap, at least partially, with the FOV of the imaging sensor 160. Additionally, the additional sensor 162 may be configured to receive and execute instructions (e.g., data acquisition parameters) from the client computing device 102 (e.g., initiated by the imaging module 146) that cause the additional sensor 162 to capture sensor data associated with objects moving across the FOV of the additional sensor 162 and/or the FOV of the imaging sensor 160. In some embodiments, one or more additional sensors 162 may correspond to one or more respective FOV (e.g., a first sensor 162 corresponding to a first FOV, a second sensor 162 corresponding to a second FOV, etc.) associated with the scanning region of the imaging device 104.

FIG. 2A illustrates a perspective view of a point-of-sale (POS) system 200a having a workstation 202a with a counter 204 and a bi-optical (also referred to as “bi-optic”) barcode reader 206 positioned partially within the workstation 202a. The POS system 200a is often managed by a store employee such as a clerk 208. However, in other cases the POS system 200a may be a part of a so-called self-checkout lane where instead of a clerk, a customer is responsible for checking out his or her own products.

The barcode reader 206 includes a lower housing 212 and a raised housing 214. The lower housing 212 includes a top portion 216 with a first optically transmissive window 218 positioned therein along a generally horizontal plane relative to the overall configuration and placement of the reader 206. The raised housing 214 is configured to be extend above the top portion 216 and includes a second optically transmissive window 220 positioned in a generally upright plane relative to the top portion 216 and/or the first optically transmissive window 218.

In practice, products, such as, for example, a bottle 222, are swiped past the reader 206 such that a barcode 224 associated where the product 222 is digitally read through at least one of the first and second optically transmissive windows 218, 220. This is particularly done by positioning the product 222 within the fields of view of the digital imaging sensor(s) housed inside the reader 206 to allow the sensor(s) to capture image data and transmit that data for further processing.

Returning to the computing environment 100 of FIG. 1, the barcode reader 206 may include the imaging device 104 and/or one or more additional imaging devices similar to the imaging device 104. For example, the barcode reader 206 may include the imaging device 104 positioned behind the first optically transmissive window 218, and the barcode reader 206 may include an additional imaging device positioned behind the second optically transmissive window 220.

In another embodiment, as depicted in FIG. 2B, a machine vision system 200b includes a machine vision device 202b (or imaging device 202b). As shown in FIG. 2B, a box 250 is moving on a conveyor belt 252 past a field of view of the imaging device 202b. The imaging device 202b can capture images of an object (e.g., the box 250), and/or the symbology (e.g., a barcode) thereon, moving through the associated FOV in order to identify the object. For example, the imaging device 202b may be the imaging device 104 of FIG. 1.

FIG. 3 illustrates a slit frame imaging process for an example scanning scenario 300. In the scenario 300, a can 302 is being scanned at a bi-optic barcode reader 304 (e.g., the bi-optic barcode reader 206 of FIG. 2A) including a sensor having a field of view (FOV) associated with a scanning region. FIG. 3 illustrates the field of view (FOV) of the sensor (e.g., the imaging sensor 160 of FIG. 1) at three distinct times (e.g., the FOV at time 306a, the FOV at time 306b, and the FOV at time 306c), as the can 302 passes through the scanning region of the bi-optic barcode reader 304. As mentioned above, an example sensor, such as the imaging sensor 160, may be a large resolution sensor that is mounted sideways, thereby allowing for slit frames to be captured sequentially, and the FOV of a sensor may correspond to the pixel area of the sensor. For example, columns or rows of the pixel area of the sensor (e.g., columns/rows of individual pixels and/or columns/rows of one or more pixels) may correspond to respective slit frames (e.g., slit frame 310) of the FOV of the sensor and the entire pixel area may correspond to the entire FOV of the sensor. As illustrated in FIG. 3, the exemplary slit frame imaging process includes activating a portion of the pixel area of a sensor corresponding to a portion of the FOV of the sensor associated with a position of an object, and/or activating a portion of the pixel area of the sensor corresponding to slit frames from the sensor associated with the position of an object (e.g., the collection of slit frames 320, the collection of slit frames 322, and the collection of slit frames 324). Said another way, the exemplary slit frame imaging process includes implementing a shifting sensor-based slit frame region of interest (ROI) (e.g., the collections of slit frames 320, 322, and 324) that follows the motion of objects (e.g., the can 302) moving across the FOV of a sensor included in the barcode reader 304.

FIG. 4 depicts an exemplary computer-implemented method 400 for implementing the techniques for modular activation of imaging sensors disclosed herein, according to an aspect. The method 400 may be implemented by the processors 130, and/or other suitable processors, etc., executing instructions stored on the memories 140, and/or another suitable non-transitory computer readable medium, etc., described above with respect to FIG. 1-3.

The method 400 may begin at block 402 when a portion of a field of view (FOV) of an imaging sensor associated with a position of an object is determined (e.g., by via the client computing device 102 of FIG. 1). In some embodiments, determining the portion of the FOV associated with the position of the object includes: detecting, in an initial image captured by the imaging sensor, an image feature associated with the object; identifying the detected image feature across at least two consecutive images; determining, based on the at least two consecutive images, a motion of the object (e.g., a velocity, acceleration, and/or direction of the object) within the FOV; and determining, based on the motion of the object, a predicted position of the object within the FOV, in an image subsequent to the at least two consecutive images, corresponding to the portion of the FOV associated with the position of the object. For example, detecting the image feature may include detecting at least one of: a one dimensional (1D) barcode, a symbology, one or more corners of an object, or one or more edges of an object. In some embodiments, determining the portion of the FOV associated with the position of the object includes: detecting, in an initial image captured by the imaging sensor, a blurred image feature associated with the object; determining, based on the blurred image feature, a motion of the object within the FOV; and determining, based on the motion of the object, a predicted position of the object within the FOV, in an image subsequent to the initial image, corresponding to the portion of the FOV associated with the position of the object. In some embodiments, determining the portion of the FOV associated with the position of the object includes: determining, using an optical flow algorithm and based on at least two consecutive images, a predicted position of the object within the FOV, in an image subsequent to the at least two consecutive images, corresponding to the portion of the FOV associated with the position of the object. For example, the imaging sensor may be an integrated optical flow imaging sensor.

In some embodiments, the imaging sensor is a first imaging sensor and the method 400 further includes determining the position of the object based on sensor data captured by a second sensor. For example, the second sensor may be: a light detection and ranging (LiDAR) sensor, a depth tracking sensor, a time of flight sensor, or an ultra-sonic sensor. In some embodiments, the first imaging device and/or the second imaging device have a FOV of high resolution and is/are included in an imaging device. In some embodiments, the imaging device is included in: a bi-optic imaging station, or a machine vision station.

At block 404, a portion of the imaging sensor corresponding to the portion of the FOV associated with the position of the object is activated (e.g., by the example computing system). For example, the portion of the imaging sensor may be a sub-section of a pixel area of the imaging sensor and the pixel area of the imaging sensor may correspond to the FOV of the imaging sensor. In some embodiments, the method 400 further includes bounding the pixel area of the imaging sensor based on the portion of the FOV associated with the position of the object, wherein the pixel area is bound horizontally, bound vertically, or bound both horizontally and vertically.

At block 406, one or more images captured by the portion of the imaging sensor to identify a feature of the object are analyzed (e.g., by the example computing system). In some embodiments, the method 400 further includes identifying a symbology depicted within the identified feature of the object and decoding the symbology depicted within the identified feature of the object. In some embodiments, the method 400 further includes identifying, using a computer vision algorithm, and based on the identified feature of the object, the object.

The above description refers to a block diagram of the accompanying drawings. Alternative implementations of the example represented by the block diagram includes one or more additional or alternative elements, processes and/or devices. Additionally or alternatively, one or more of the example blocks of the diagram may be combined, divided, re-arranged or omitted. Components represented by the blocks of the diagram are implemented by hardware, software, firmware, and/or any combination of hardware, software and/or firmware. In some examples, at least one of the components represented by the blocks is implemented by a logic circuit. As used herein, the term “logic circuit” is expressly defined as a physical device including at least one hardware component configured (e.g., via operation in accordance with a predetermined configuration and/or via execution of stored machine-readable instructions) to control one or more machines and/or perform operations of one or more machines. Examples of a logic circuit include one or more processors, one or more coprocessors, one or more microprocessors, one or more controllers, one or more digital signal processors (DSPs), one or more application specific integrated circuits (ASICs), one or more field programmable gate arrays (FPGAs), one or more microcontroller units (MCUs), one or more hardware accelerators, one or more special-purpose computer chips, and one or more system-on-a-chip (SoC) devices. Some example logic circuits, such as ASICs or FPGAs, are specifically configured hardware for performing operations (e.g., one or more of the operations described herein and represented by the flowcharts of this disclosure, if such are present). Some example logic circuits are hardware that executes machine-readable instructions to perform operations (e.g., one or more of the operations described herein and represented by the flowcharts of this disclosure, if such are present). Some example logic circuits include a combination of specifically configured hardware and hardware that executes machine-readable instructions. The above description refers to various operations described herein and flowcharts that may be appended hereto to illustrate the flow of those operations. Any such flowcharts are representative of example methods disclosed herein. In some examples, the methods represented by the flowcharts implement the apparatus represented by the block diagrams. Alternative implementations of example methods disclosed herein may include additional or alternative operations. Further, operations of alternative implementations of the methods disclosed herein may combined, divided, re-arranged or omitted. In some examples, the operations described herein are implemented by machine-readable instructions (e.g., software and/or firmware) stored on a medium (e.g., a tangible machine-readable medium) for execution by one or more logic circuits (e.g., processor(s)). In some examples, the operations described herein are implemented by one or more configurations of one or more specifically designed logic circuits (e.g., ASIC(s)). In some examples the operations described herein are implemented by a combination of specifically designed logic circuit(s) and machine-readable instructions stored on a medium (e.g., a tangible machine-readable medium) for execution by logic circuit(s).

As used herein, each of the terms “tangible machine-readable medium,” “non-transitory machine-readable medium” and “machine-readable storage device” is expressly defined as a storage medium (e.g., a platter of a hard disk drive, a digital versatile disc, a compact disc, flash memory, read-only memory, random-access memory, etc.) on which machine-readable instructions (e.g., program code in the form of, for example, software and/or firmware) are stored for any suitable duration of time (e.g., permanently, for an extended period of time (e.g., while a program associated with the machine-readable instructions is executing), and/or a short period of time (e.g., while the machine-readable instructions are cached and/or during a buffering process)). Further, as used herein, each of the terms “tangible machine-readable medium,” “non-transitory machine-readable medium” and “machine-readable storage device” is expressly defined to exclude propagating signals. That is, as used in any claim of this patent, none of the terms “tangible machine-readable medium,” “non-transitory machine-readable medium,” and “machine-readable storage device” can be read to be implemented by a propagating signal.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. Additionally, the described embodiments/examples/implementations should not be interpreted as mutually exclusive, and should instead be understood as potentially combinable if such combinations are permissive in any way. In other words, any feature disclosed in any of the aforementioned embodiments/examples/implementations may be included in any of the other aforementioned embodiments/examples/implementations.

The benefits, advantages, solutions to problems, and any element(s) that may cause any benefit, advantage, or solution to occur or become more pronounced are not to be construed as a critical, required, or essential features or elements of any or all the claims. The claimed invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter may lie in less than all features of a single disclosed embodiment. Thus, the following claims are hereby incorporated into the Detailed Description, with each claim standing on its own as a separately claimed subject matter.

What is claimed is:

1. A computing system comprising:
one or more processors;
an imaging device including an imaging sensor having a field of view (FOV) of high resolution, wherein the imaging device is in a fixed position relative to the FOV; and
one or more memories including computer-executable instructions that, when executed by the one or more processors, cause the computing system to:
determine a portion of the FOV associated with a position of an object;
activate a portion of the imaging sensor corresponding to the portion of the FOV associated with the position of the object; and
analyze one or more images captured by the portion of the imaging sensor to identify a feature of the object.

2. The computing system of claim 1, the one or more memories further including computer-executable instructions that, when executed by the one or more processors, determine the portion of the FOV associated with the position of the object by causing the computing system to:
detect, in an initial image captured by the imaging sensor, an image feature associated with the object;
identify the detected image feature across at least two consecutive images;
determine, based on the at least two consecutive images, a motion of the object within the FOV; and
determine, based on the motion of the object, a predicted position of the object within the FOV, in an image subsequent to the at least two consecutive images, corresponding to the portion of the FOV associated with the position of the object.

3. The computing system of claim 2, wherein detecting the image feature includes detecting at least one of: a one dimensional barcode, a symbology, one or more corners of an object, or one or more edges of an object.

4. The computing system of claim 1, the one or more memories further including computer-executable instructions that, when executed by the one or more processors, determine the portion of the FOV associated with the position of the object by causing the computing system to:
detect, in an initial image captured by the imaging sensor, a blurred image feature associated with the object;
determine, based on the blurred image feature, a motion of the object within the FOV; and
determine, based on the motion of the object, a predicted position of the object within the FOV, in an image subsequent to the initial image, corresponding to the portion of the FOV associated with the position of the object.

5. The computing system of claim 1, the one or more memories further including computer-executable instructions that, when executed by the one or more processors, determine the portion of the FOV associated with the position of the object by causing the computing system to:
determine, using an optical flow algorithm and based on at least two consecutive images, a predicted position of the object within the FOV, in an image subsequent to the at least two consecutive images, corresponding to the portion of the FOV associated with the position of the object.

6. The computing system of claim 5, wherein the imaging sensor is an integrated optical flow imaging sensor.

7. The computing system of claim 1, the one or more memories further including computer-executable instructions that, when executed by the one or more processors, cause the computing system to:
identify a symbology depicted within the identified feature of the object; and
decode the symbology depicted within the identified feature of the object.

8. The computing system of claim 1, the one or more memories further including computer-executable instructions that, when executed by the one or more processors, cause the computing system to:
identify, using a computer vision algorithm and based on the identified feature of the object, the object.

9. The computing system of claim 1, wherein the portion of the imaging sensor is a sub-section of a pixel area of the imaging sensor and wherein the pixel area of the imaging sensor corresponds to the FOV of the imaging sensor.

10. The computing system of claim 9, the one or more memories further including computer-executable instructions that, when executed by the one or more processors, cause the computing system to:
bound the pixel area of the imaging sensor based on the portion of the FOV associated with the position of the object, wherein the pixel area is bound horizontally, bound vertically, or bound both horizontally and vertically.

11. The computing system of claim 1, wherein the imaging sensor is a first imaging sensor,
the computing system further comprising a second sensor configured to capture sensor data associated with the object; and
the one or more memories further including computer-executable instructions that, when executed by the one or more processors, cause the computing system to:
determine the position of the object based on the sensor data captured by the second sensor.

12. The computing system of claim 11, wherein the second sensor is: a light detection and ranging (LiDAR) sensor, a depth tracking sensor, a time of flight sensor, or an ultra-sonic sensor.

13. The computing system of claim 1, wherein the imaging device is included in: a bi-optic imaging station, or a machine vision station.

14. A computer-implemented method for modular activation of an imaging sensor, the computer-implemented method comprising:
determining, by one or more processors, a portion of a FOV of an imaging sensor associated with a position of an object, the imaging sensor included in an imaging device in a fixed position relative to the FOV;
activating, by the one or more processors, a portion of the imaging sensor corresponding to the portion of the FOV associated with the position of the object; and
analyzing, by the one or more processors, one or more images captured by the portion of the imaging sensor to identify a feature of the object.

15. The computer-implemented method of claim 14, further comprising:
detecting, by the one or more processors and in an initial image captured by the imaging sensor, an image feature associated with the object;
identifying, by the one or more processors, the detected image feature across at least two consecutive images;
determine, by the one or more processors and based on the at least two consecutive images, a motion of the object within the FOV; and
determine, by the one or more processors and based on the motion of the object, a predicted position of the object within the FOV, in an image subsequent to the at least two consecutive images, corresponding to the portion of the FOV associated with the position of the object.

16. The computer-implemented method of claim 14, further comprising:
detecting, by the one or more processors and in an initial image captured by the imaging sensor, a blurred image feature associated with the object;
determining, by the one or more processors and based on the blurred image feature, a motion of the object within the FOV; and
determining, by the one or more processors and based on the motion of the object, a predicted position of the object within the FOV, in an image subsequent to the initial image, corresponding to the portion of the FOV associated with the position of the object.

17. The computer-implemented method of claim 14, further comprising:
based on at least two consecutive images, determining, by the one or more processors and using an optical flow algorithm, a predicted position of the object within the FOV, in an image subsequent to the at least two consecutive images, corresponding to the portion of the FOV associated with the position of the object.

18. The computer-implemented method of claim 14, further comprising:
identifying, by the one or more processors, a symbology depicted within the identified feature of the object; and
decoding, by the one or more processors, the symbology depicted within the identified feature of the object.

19. The computer-implemented method of claim 14, further comprising:
identifying, by the one or more processors and using a computer vision algorithm, the object based on the identified feature of the object.

20. The computer-implemented method of claim 14, wherein the portion of the imaging sensor is a sub-section of a pixel area of the imaging sensor, wherein the pixel area of the imaging sensor corresponds to the FOV of the imaging sensor, and the computer-implemented method further comprises:
bounding, by the one or more processors, the pixel area of the imaging sensor based on the portion of the FOV associated with the position of the object, wherein the pixel area is bound horizontally, bound vertically, or bound both horizontally and vertically.
